(19) United States
(12) Patent Application Publication
(10) Pub. No.: US 2026/0352564 A1
(43) Pub. Date: Nov. 5, 2026

(54) DATA CONTROLS FOR A DISTRIBUTED CLOUD ENVIRONMENT

(71) Applicant: Bank of America Corporation, Charlotte, NC (US)

(72) Inventors: Sukanya V, Chennai (IN); Vinod Maghnani, Gurugram (IN)

(21) Appl. No.: 19/196,819

(22) Filed: May 2, 2025

(51) Int. Cl. H04L 41/16; G06N 3/044; G06N 3/0455; H04L 67/10

(52) U.S. Cl. CPC H04L 41/16; G06N 3/044; G06N 3/0455; H04L 67/10

(57) ABSTRACT

Systems, methods, and apparatus are provided for data controls for a distributed cloud environment. A first AI/ML model may include a recurrent neural network (RNN). The first AI/ML model may weight an input sequence based on criticality and classify the input sequence based on a level of security. A second AI/ML model may include generative AI algorithms and may encode the classified input sequence as a synthetic data image stored in a first synthetic data block in a distributed cloud container. A data capsule may be generated including a set of data validation rules and a variational autoencoder (VAE). The VAE may generate a second synthetic data block from the encoded input sequence and validate the second synthetic data block. The VAE may restore the input sequence in response to an authorized request for data retrieval.

### FIELD OF TECHNOLOGY

Aspects of the disclosure relate to data quality and privacy controls in a large-scale distributed cloud environment.

### BACKGROUND OF THE DISCLOSURE

A distributed cloud may include multiple cloud clusters processing and storing massive amounts of data. Distributed cloud infrastructure may adaptively distribute a computing stack for a cloud provider to wherever a customer might need it. A public crowd provider may distribute resources both on-premises in the customer data center or a private cloud, and off-premises in one or more public cloud data centers.

Legacy data quality and data privacy controls are challenging to implement in a distributed cloud environment. For example, the data switching inherent in the distributed cloud infrastructure and the massive volume of data make it challenging to manage controls in real time.

It would be desirable to implement a robust computational platform to securely process data and implement data quality and privacy controls in a distributed cloud environment.

### SUMMARY OF THE DISCLOSURE

Systems, methods, and apparatus are provided for data controls for a distributed cloud environment.

A first AI/ML model may include a recurrent neural network (RNN). The first AI/ML model may weight an input sequence based on criticality. The first AI/ML model may classify the input sequence based on a level of security. Classification for a set of input sequences may be ordered based on the criticalities.

A second AI/ML model may include generative AI algorithms. The second AI/ML model may encode the classified input sequence as a synthetic data image. The synthetic data image may be stored in a first synthetic data block in a distributed cloud container.

A data capsule may be generated including a set of data validation rules and a variational autoencoder (VAE). The data capsule may be inserted into the first synthetic data block.

The VAE may generate a second synthetic data block from the encoded input sequence. The VAE may join data that was stored without primary indexing in multiple cloud containers.

The VAE may validate the second synthetic data block using the data validation rules. The VAE may validate data archiving and disposal activity. In some embodiments, the VAE may generate validation rules specific to a cloud container or cluster.

The VAE may restore the input sequence from the synthetic data block in response to an authorized request for data retrieval. In some embodiments, the data from the first synthetic data block may be restored before processing the data through the VAE.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative process flow in accordance with principles of the disclosure; and

FIG. 4 shows an illustrative process flow in accordance with principles of the disclosure.

### DETAILED DESCRIPTION

Systems, methods, and apparatus are provided for data controls for a distributed cloud environment.

For the sake of illustration, the invention will be described as being performed by a “system.” The system may include one or more features of apparatus and methods that are described herein and/or any other suitable device or approach.

Data quality controls may validate data to check for anomalies such as inconsistency and incompleteness. Data privacy controls may validate data to check for anomalies in security and access protocols.

The system may process data into synthetic data blocks instead of conventional formats such as number bundles or buckets. Synthetic data blocks may store the large masses of data associated with a distributed cloud environment more efficiently. The synthetic data blocks may include synthesized data images.

The system may convert enterprise level data into synthetic data images using recurrent neural networks (RNNs) and generative artificial intelligence (AI). The synthetic data images may be stored in distributed cloud containers and synthetic data clients. Processing the enterprise data as synthetic data provides an additional layer of protection against misappropriation by bad actors. Even if a bad actor was able to obtain access, they would not be able to reconstruct the original data.

Packets of capsule data may be injected into the synthetic data blocks to validate the data controls and identify anomalies. Data injection may also be known as data insertion. Data injection or insertion may include populating input fields with embedded control or command sequences. The inserted data may be accepted by the application or passed to the operating system.

The data capsules may include variational autoencoders (VAEs). VAEs are generative machine learning models that generate new data similar to the training input. An encoder component may learn patterns and generate latent variables from the input data. A decoder component may use the latent variables to reconstruct the input. VAEs may map the encoder input to a distribution in the latent space, introducing randomness so the decoder may output slightly different data that is still realistic.

The capsules may include data validation rules created for particular domain or organization. The rules may be specific to a particular cluster or cloud container. The capsules may validate the data quality rules and process the data through the VAEs.

The system may receive an input sequence. The input sequence may include a dataset, file, folder, or any suitable data format. The input sequence may be input to a first artificial intelligence/machine learning (AI/ML) model. The first AI/ML model may include an RNN. The RNN may include an encoder and a decoder. The data may be encoded for input into the model and later decoded for output.

A second AI/ML model may be applied to tune and auto-adjust the RNN. The AI/ML model may assign weights within the RNN. The weights may be based at least in part on the criticality of the data. The criticality may be determined based on enterprise priorities, processing time, data sensitivity, and/or on any suitable criteria. For example, processing data associated with a real-time transaction may be deemed more critical than processing a request to view a customer balance.

A third AI/ML model may include one or more classification algorithms. The classification algorithms may be linear or non-linear and may include any suitable algorithms. The classification algorithms may classify the input data based on a level of security. For example, the classification algorithms may determine whether the data is public data or private data.

If data is all of the same criticality, such as when processing data from one cluster or one cloud domain, there may be no need for weighting. In this case, the data may proceed from the first AI/ML model directly to the classification model.

Output from the classification model may be input to a fourth AI/ML model. The fourth AI/ML model may include generative AI and may generate synthetic data images from the output of the classification model. The system may store the synthetic data images in synthetic data blocks. Block storage may be optimized for fast access and retrieval, which is important in handling the vast amount of data in a distributed cloud architecture. Unlike more conventional file system storage, block storage may be adaptable to accommodate the real-time switches associated with a distributed cloud. Block storage also may store data in a compressed format, eliminating the need for heavy storage containers.

The data in the synthetic data blocks may be validated for data quality and data privacy. The system may generate capsules of data that include data control rules. The capsules may include a VAE to process the data and validate the data control rules. The data may be conjugated by joining stored data from tables, databases, cloud containers or any suitable locations.

The VAE may process the data and generate synthetic data blocks. The synthetic data blocks may be validated for data quality controls. The synthetic data blocks may be validated for data privacy controls. The VAE may monitor archiving and disposal of data. Following validation, the data may be extracted and decoded to provide to an authorized user.

In some embodiments, the synthetic data image may be decoded to provide input for the VAE. The VAE may process the input data stream through the VAE algorithm.

One or more non-transitory computer-readable media storing computer-executable instructions are provided. When executed by a processor on a computer system, the instructions may perform a method for data validation in a distributed cloud environment.

The method may include, at a first AI/ML model that includes an RNN, weighting an input sequence based on criticality; and classifying the input sequence based on a level of security, The classification algorithm may process a set of input sequences in an order based on their criticality.

The method may include, at a second AI/ML model that includes generative AI, encoding the classified input sequence. The encoding may include generating a synthetic data image from the classified input sequence. The method may include storing the synthetic data image in a first synthetic data block in a distributed cloud container.

The method may include generating a data capsule that includes a set of data validation rules and a variational autoencoder (VAE). In some embodiments, the VAE may generate validation rules specific to a cloud container. The method may include inserting the data capsule into the first synthetic data block.

The method may include, using the VAE, generating a second synthetic data block from the encoded input sequence. The VAE may use AI to locate and join data from multiple cloud containers. The VAE may join data that was stored without primary indexing.

The method may include validating the second synthetic data block using the data validation rules. The VAE may also validate data archiving and disposal activity. The method may include restoring the input sequence in response to an authorized request for data retrieval.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

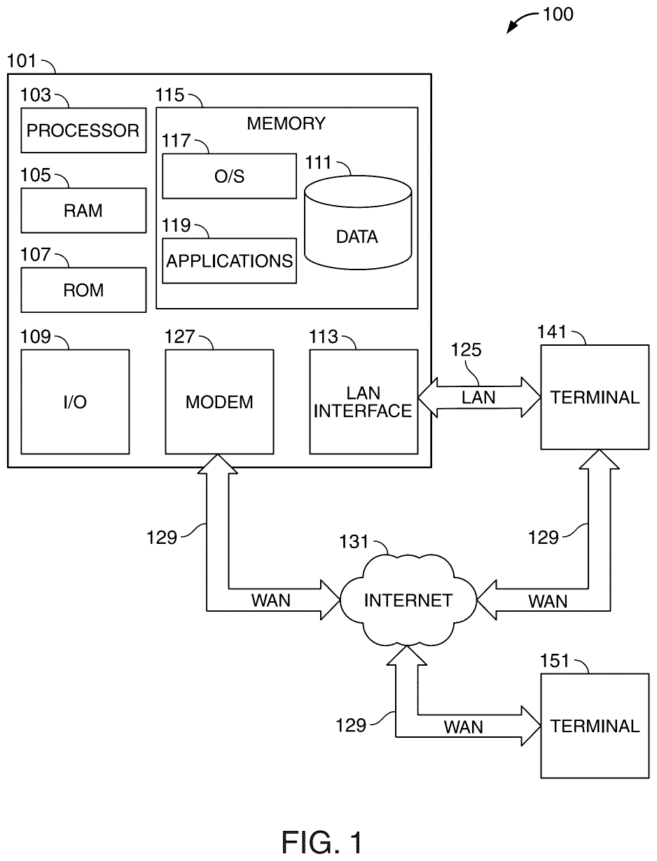

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general-purpose or special-purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

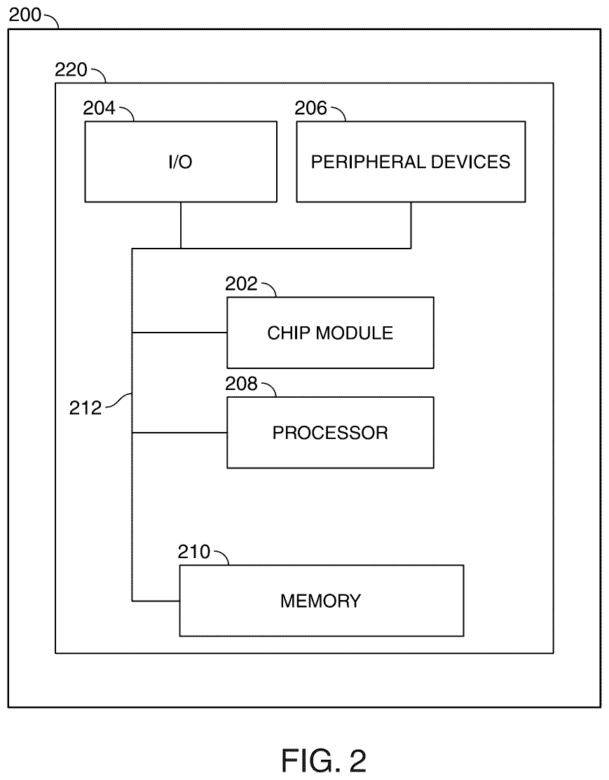

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

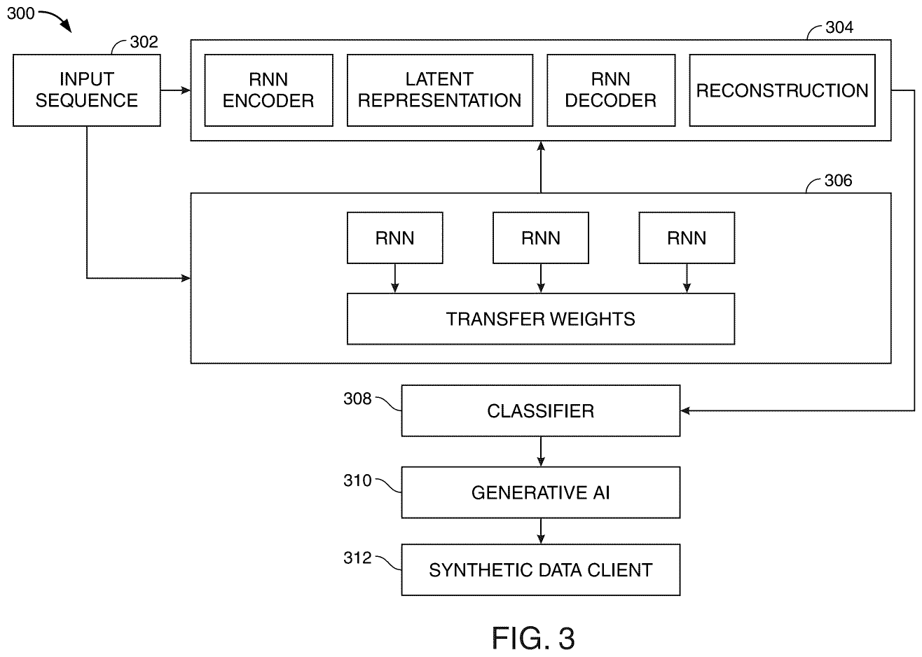

FIG. 3 shows illustrative process flow 300 for data controls in a distributed cloud environment. Input sequence 302 may be processed at AI/ML model 304. AI/ML model 304 may include a recurrent neural network (RNN). The RNN may include an encoder stage, a latent representation state, a decoder stage, and a reconstruction component.

Input sequence 302 may be processed at AI/ML model 306. AI/ML model 306 may include multiple RNNs. AI/ML model 306 may recalculate the transfer weights in AI/ML model 304 or in any component of any RNN in the system. The transfer weights may be adjusted based on the criticality of the input sequence. The criticality may be determined based on enterprise priorities, processing time, data sensitivity, and/or on any suitable criteria.

The output from AI/ML model 304 may be input to AI/ML model 308. AI/ML model 308 may include any suitable classification algorithms. AI/ML model 308 may classify the input sequence based on a level of sensitivity. For example, the data may be classified as public or private. The data may be classified based on a level of access.

The output from AI/ML model 308 may be input to AI/ML model 310. AI/ML model 310 may include generative AI algorithms. AI/ML model 310 may be a generative adversarial network or any suitable algorithm. AI/ML model 310 may generate a synthetic data image from the classified input sequence. The synthetic data image may be stored at synthetic data client 312.

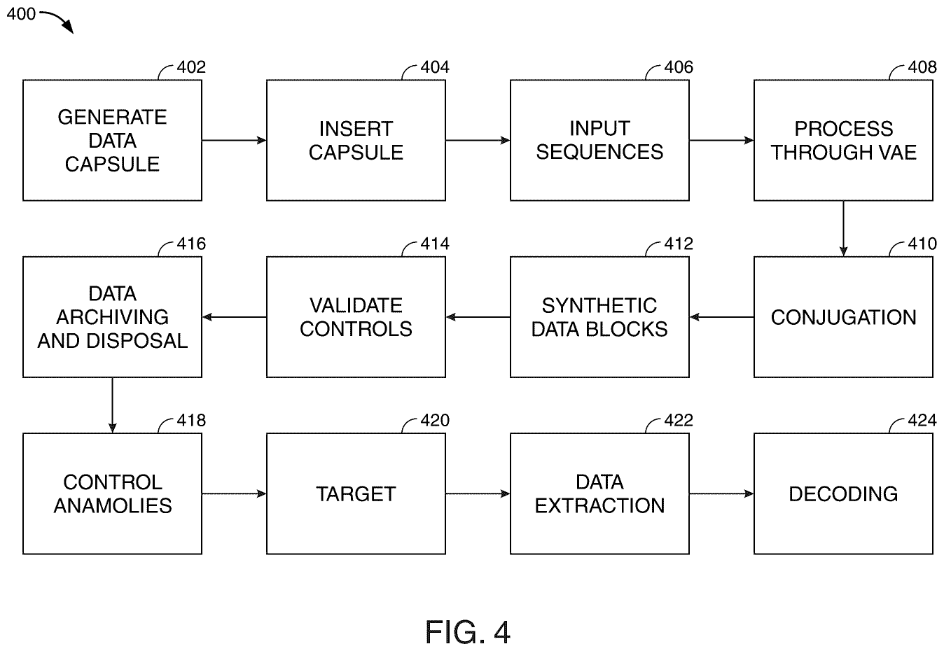

FIG. 4 shows illustrative process flow 400 for data controls in a distributed cloud environment.

At 402, a data capsule may be generated. The data capsule may include data validation rules. The data capsule may include a variational autoencoder (VAE). At 404, the capsule may be inserted into stored data. At 406, the VAE may access an input sequence. The input sequence may correspond to input sequence 302, shown in FIG. 3. Input sequence 406 may be encoded as a synthetic data image or may be decoded before insertion of the capsule.

At 408, the input sequence may be processed through the VAE. At 410, the VAE may join additional data. Additional data may be stored in the same domain or in a different part of the distributed cloud. The VAE may locate join related data that is not linked by primary indexing. At 412, the VAE may generate synthetic data blocks from the input sequence and the joined data.

At 414, the validation rules may be applied to the synthetic data. The system may validate data privacy controls, data quality controls, and/or any suitable controls. In some embodiments, the VAE may generate validation rules targeted to a specific cloud container. At 416, the system may validate data archiving and disposal protocols.

At 418, anomalies in control data may be detected and reported. At 420, the validated control data may be transferred to a target system or database. At 422, data may be extracted from the target system in response to a request from an authorized party. At 424, the data may be decoded and provided to the authorized party.

Thus, methods and apparatus for DATA CONTROLS FOR A DISTRIBUTED CLOUD ENVIRONMENT are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for data controls in a distributed cloud environment, the method comprising:
at a first AI/ML model comprising a recurrent neural network (RNN):
weighting an input sequence based on criticality; and
classifying the input sequence based on a level of security, an order for the classifying based on the criticality;
at a second AI/ML model comprising generative AI, encoding the classified input sequence, the encoding comprising generating a synthetic data image from the classified input sequence;
storing the synthetic data image in a first synthetic data block in a distributed cloud;
generating a data capsule comprising a set of data validation rules and a variational autoencoder (VAE), and inserting the data capsule into the first synthetic data block;
using the VAE, generating a second synthetic data block from the encoded input sequence;
validating the second synthetic data block using the data validation rules; and
restoring the input sequence in response to an authorized request for data retrieval.

2. The method of claim 1, the VAE further configured to join stored data without primary indexing from multiple cloud containers.

3. The method of claim 1, further comprising validating data archiving and disposal activity using the VAE.

4. The method of claim 1, further comprising storing the first synthetic data block in a distributed cloud container comprising a synthetic data client.

5. The method of claim 1, wherein the first synthetic data block stores the encoded input sequence in a compressed format.

6. The method of claim 1, further comprising restoring the data from the first synthetic data block before inserting the data capsule.

7. The method of claim 1, further comprising using the VAE to generate validation rules specific to a cloud container.

8. One or more non-transitory computer-readable media storing computer-executable instructions which, when executed by a processor on a computer system, perform a method for validating data controls in a distributed cloud environment, the method comprising:
at a first AI/ML model comprising a recurrent neural network (RNN):
weighting an input sequence based on criticality; and
classifying the input sequence based on a level of security, an order for the classifying based on the criticality;
at a second AI/ML model comprising generative AI, encoding the classified input sequence, the encoding comprising generating a synthetic data image from the classified input sequence;
storing the synthetic data image in a first synthetic data block in a distributed cloud;
generating a data capsule comprising a set of data validation rules and a variational autoencoder (VAE), and inserting the data capsule into the first synthetic data block;
using the VAE, generating a second synthetic data block from the encoded input sequence;
validating the second synthetic data block using the data validation rules; and
restoring the input sequence in response to an authorized request for data retrieval.

9. The media of claim 8, the VAE further configured to join stored data without primary indexing from multiple cloud containers.

10. The media of claim 8, further comprising validating data archiving and disposal activity using the VAE.

11. The media of claim 8, further comprising storing the first synthetic data block in a distributed cloud container comprising a synthetic data client.

12. The media of claim 8, wherein the first synthetic data block stores the encoded input sequence in a compressed format.

13. The media of claim 8, further comprising restoring the data from the first synthetic data block before inserting the data capsule.

14. The media of claim 8, further comprising using the VAE to generate validation rules specific to a cloud container.

15. A system for data validation in a distributed cloud environment, the system comprising:
a first processor configured to:
at a first AI/ML model comprising a recurrent neural network (RNN):
weight an input sequence based on criticality; and
classify the input sequence based on a level of security, an order for the classifying based on the criticality;
at a second AI/ML model comprising generative AI, encode the classified input sequence, the encoding comprising generating a synthetic data image from the classified input sequence;
store the synthetic data image in a first synthetic data block in a distributed cloud;
a second processor configured to:
generate a data capsule comprising a set of data validation rules and a variational autoencoder (VAE), and insert the data capsule into the first synthetic data block;
using the VAE, generate a second synthetic data block from the encoded input sequence;
validate the second synthetic data block using the data validation rules; and
restore the input sequence in response to an authorized request for data retrieval.

16. The system of claim 15, the second processor using the VAE to join stored data without primary indexing from multiple cloud containers.

17. The system of claim 15, the second processor validating data archiving and disposal activity using the VAE.

18. The system of claim 15, the first processor storing the first synthetic data block in a distributed cloud container comprising a synthetic data client.

19. The system of claim 15, the second processor restoring the data from the first synthetic data block before inserting the data capsule.

20. The system of claim 15, the second processor using the VAE to generate validation rules specific to a cloud container.
